(19) United States
(12) Patent Application Publication
(10) Pub. No.: US 2009/0041570 A1
(43) Pub. Date: Feb. 12, 2009

(54) Fork Lift Truck With Elastically Fastened Drive Axle And Lift Mast Tiltably Mounted Thereon

(75) Inventors: Bernhard Gotz, Deutschland (DE); Harald Will, Deutschland (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Material Handling GmbH, Aschaffenburg (DE)

(21) Appl. No.: 12/175,482

(22) Filed: Jul. 18, 2008

(30) Foreign Application Priority Data
Aug. 9, 2007 (DE) 10 2007 037 523.0

(51) Int. Cl. B66F 19/00

(52) U.S. Cl. 414/607

(57) ABSTRACT

A fork lift truck drive axle (1′) is elastically fastened to a vehicle frame and with a lift mast (8) connected with the drive axle (1′) and can be inclined around an axial centerline (A) of the drive axle (1′) by at least one tilting cylinder (10). The drive axle (1′) is fastened to the vehicle frame by forward bearing elements (5) and by rear bearing elements (6) of a torque bearing system (torque arms 2a, 2b). The drive axle (1′) can be pivoted around a swiveling axis (S) oriented horizontally and transversely in the vicinity of the rear bearing elements (6). The lift mast (8) can also be inclined relative to the drive axle (1). The tilting cylinder (10) is connected in an articulated manner to the vehicle frame and the lift mast (8) and is oriented parallel or approximately parallel to a plane (E) which extends from the axial centerline (A) to the swiveling axis (S).

### CROSS REFERENCE TO RELATED APPLICATION

This application claims priority to German Application No. 10 2007 037 523.0, filed Aug. 9, 2007, which is herein incorporated by reference in its entirety.

### BACKGROUND OF THE INVENTION

1. Field of the Invention

This invention relates to a fork lift truck with a drive axle flexibly fastened to a vehicle frame. A lift mast is connected with the drive axle and can be tilted around an axial centerline of the drive axle by at least one tilting cylinder.

2. Technical Considerations

On known fork lift truck models “H35”, “H40” and “H45” manufactured by Linde AG of Aschaffenburg, Germany, the lift mast is tiltably mounted on the vehicle frame, while the drive axle is elastically supported on the vehicle frame by a plurality of bearing elements. In this case, the drive axle has a tubular axle body and extension arms which are connected to it and extend toward the rear. The drive axle is elastically fastened to the vehicle frame by forward bearing elements located on the axle body and by rear bearing elements located on the extension arms. Consequently, there are two front and two rear bearing elements, each of which is separated in the transverse direction of the vehicle from the other bearing element in its respective pair.

On this known fork lift truck, the drive and braking torques of the drive axle are supported by the extension arms via the rear bearing elements on the vehicle frame. The forces created by the load being carried and by the lift mast are transmitted into the floor or roadway via the vehicle frame and, thus, via the front bearing elements of the drive axle.

The bearing elements of this drive axle must be configured so that they are relatively rigid to guarantee sufficient stability of the fork lift truck. Any bumps that occur during travel because of irregularities in the floor or road surface can therefore be damped by the bearing elements only to a limited extent.

DE 100 29 881 A1 describes a similar fork lift truck. On the drive axle of this fork lift truck, ring-shaped bearing elements (rubber-metal bearings) surround an axle tube of the drive axle. This type of fastening of a drive axle makes it possible to use the bearing elements as tilting bearings for the lift mast, which is rigidly fastened to the drive axle. To tilt the lift mast, the drive axle is rotated around its axial centerline.

On this fork lift truck, the weight resulting from the load being carried and the mass of the lift mast are transmitted to it into the floor or roadway directly via the drive axle and the wheels fastened to it, bypassing the vehicle frame and the bearing elements. The drive and braking torques of the drive axle are absorbed by the tilting cylinders of the vehicle frame that are located at a great distance from the bearing elements (conventionally termed “top-mounted tilting cylinders”). Because the bearing elements of the drive axle do not have to absorb either vertical forces on the lift mast side or drive and braking torques, they can be relatively soft. As a result of which, irregularities in the road surface or floor are transmitted to the vehicle frame only after a great deal of damping has occurred.

As a result of the top-mounted location of the tilting cylinders, in the event of large deformations of the bearing elements, the resulting changes in the position and inclination of the lift mast remain relatively small. On the other hand, when tilting cylinders are used that are located close to the drive axle (conventionally termed “bottom-mounted tilting cylinders”), this leads in the event of a deflection of the drive axle to an undesirable tilting movement of the lifting frame and to the excitation of vibrations.

Therefore, it is an object of the invention to provide a fork lift truck of the general type described above but in which a relatively soft bearing system for the drive axle and thus an effective damping of road bumps is possible, and in which the location of the tilting cylinders is not limited to top-mounted tilting cylinders.

### SUMMARY OF THE INVENTION

In one non-limiting embodiment of the invention, the drive axle is fastened to the vehicle frame by forward bearing elements and by rear elements of a torque arm located at some distance from the forward bearing elements in the longitudinal direction of the vehicle frame. The forward bearing elements are realized for the absorption of vertical forces and the rear bearing elements for the absorption of drive and braking torques. The drive axle can be swiveled around a swiveling axis oriented horizontally transversely and located in the vicinity of the rear bearing elements. The lift mast can be tilted relative to the drive axle. The at least one tilting cylinder is connected via joints with the vehicle frame and the lift mast and is oriented parallel or approximately parallel to a plane that extends from the axial centerline to the swiveling axis.

A teaching of the invention is, correspondingly, on a generic fork lift truck having a lift mast connected with the drive axle to provide the drive axle with a torque arm, and to connect it with the lift mast mounted to the vehicle frame so that it can tilt relative to the drive axle and its axial centerline in the manner of a parallelogram. As a result of the axially mobile coupling points of the lift mast, of the tilting cylinder or cylinders and the drive axis, a joint polygon is created which, when the vehicle encounters irregularities in the floor or road surface, permits deflections of the drive axle in the form of swiveling movements whereby, however, the lift mast changes its vertical position, i.e., the tilting position changes either only insignificantly or not at all and tilting oscillations are not excited.

The forward bearing elements absorb the vertical forces and can be optimized in terms of the damping characteristics with respect to irregularities in the road or floor and can have correspondingly long spring deflections. Depending on the constructive design, it is also possible for the forward bearing elements to absorb transverse forces, i.e., forces in the axial direction of the drive axle. Alternatively, however, special axial stops can also be provided so that the forward bearing elements are subjected exclusively to vertical forces.

The drive and braking torques of the drive axle are transmitted into the vehicle frame by rear bearing elements which, in spite of their elasticity, are realized so that they are relatively stiff. These bearing elements can optionally also introduce forces that act in the longitudinal direction of the vehicle into the vehicle frame and, thus, limit the travel of the drive axle, unless special limiting devices (stops) for this purpose are provided in the longitudinal direction of the vehicle.

As a result of the articulated mounting of the lift mast relative to the drive axle, as a result of which a tilting movement around the axial centerline becomes possible, the weights that are produced by the load being carried and the mass of the lift mast are applied in the center of the drive axle. The vertical forces are transmitted to the road or floor directly via the wheels of the drive axle.

The fork lift truck of the invention, as a result of the parallelogram-like joint polygon including the drive axle with the torque arms, the lift mast and the tilting cylinder(s), and as a result of the relatively soft realization of the forward bearing elements, makes possible high spring deflections of the drive axle.

It has been found to be advantageous if the forward bearing elements are also realized so that they can absorb horizontal transverse forces. The drive axle is thereby guided in the lateral direction.

In one advantageous configuration of the invention, the drive axle has an axle body to which are rigidly fastened two torque arms that are at some distance from each other in the transverse direction of the vehicle and extend toward the rear. The forward bearing elements are in an operational connection with the axle body and each rear bearing element is in an operational connection with one of the torque arms, respectively.

If the swiveling axis is at a smaller vertical distance from the floor or road surface than the axial centerline, the result is on one hand a reduced space requirement for the drive axle provided with torque arms in the vehicle frame, and on the other hand the flow of forces is optimized.

Additional advantages and details of the invention are explained in greater detail below on the basis of the exemplary embodiment illustrated in the accompanying embodiment.

### BRIEF DESCRIPTION OF THE DRAWINGS

FIG. 1 is a perspective view of a drive axle of a known fork lift truck;

FIG. 2 is a perspective view of a vehicle frame of a known fork lift truck;

FIG. 3 is a side view of a forward portion of a fork lift truck of the invention;

FIG. 4 is a plan view of the arrangement illustrated in FIG. 3; and

FIG. 5 is a side view of a forward area of a variant of the fork lift truck of the invention.

### DESCRIPTION OF THE PREFERRED EMBODIMENTS

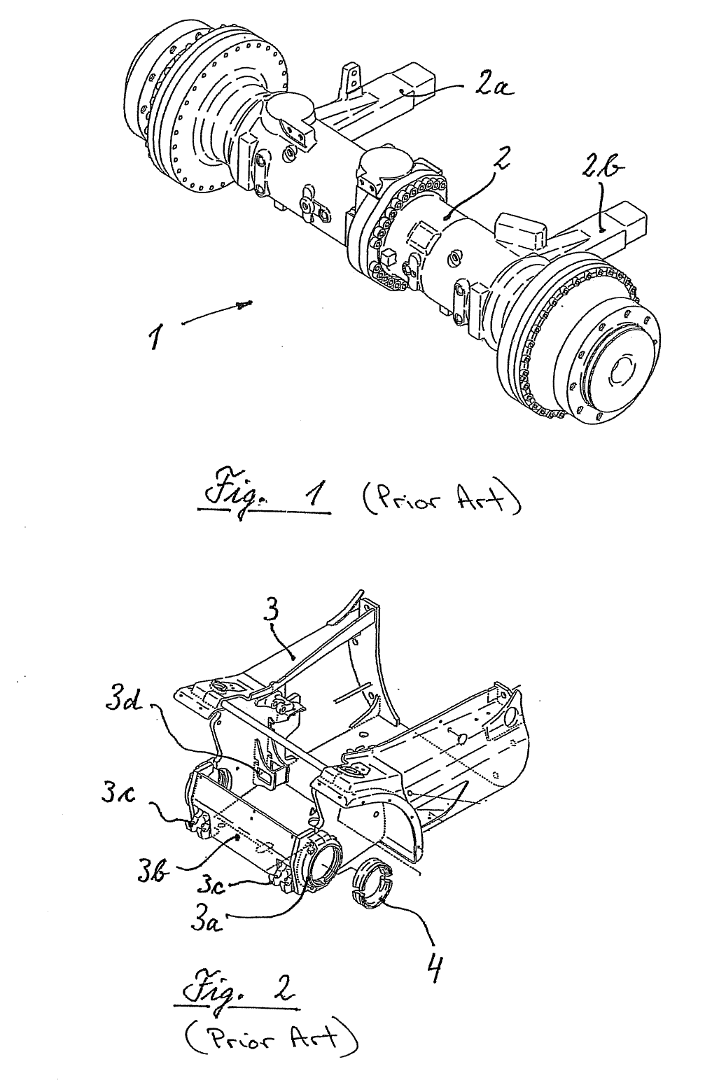

As shown in FIG. 1, the drive axle 1 comprises a tubular axle body 2 and two torque arms 2a, 2b that extend toward the rear in the direction of travel and are non-detachably connected with the axle body 2, e.g., by being cast in one piece with it.

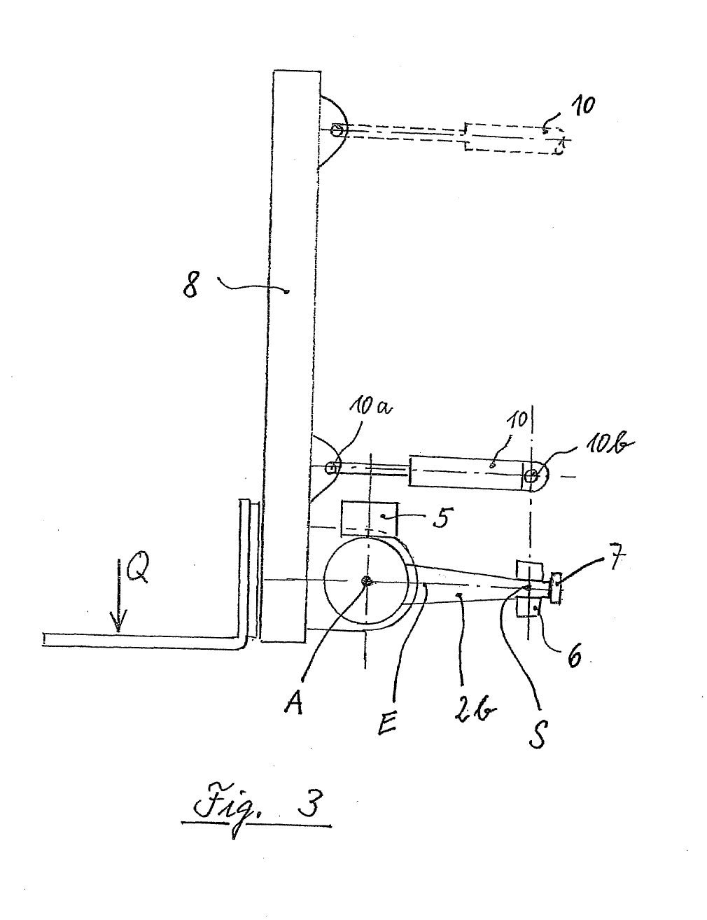

This drive axle 1 is fastened elastically to the vehicle frame 3 (FIG. 2) of the fork lift truck. For this purpose, ring-shaped forward bearing elements realized in the form of rubber-metal bearings 4 are provided which surround the axle body 2 when it is installed, and rear bearing elements (not shown) realized in the form of rubber bushings which are pushed onto the torque levers 2a, 2b. In the installed position, the axle body 2 of the drive axle 1 is clamped in the split bearing element receptacles 3a of the vehicle frame 3, whereby the forward halves of the bearing element receptacles 3a in the direction of travel are connected with each other by a transverse partition 3b on which there are tilting bearings 3c for a lift mast. The rear ends of the torque arms 2a, 2b are inserted with the pushed-on rubber bushings in receptacle pockets 3d in the vehicle frame 3.

In this construction, the weights applied vertically downwardly and caused by the load being transported and the mass of the lift mast, are first transmitted via the tilting bearing 3c and the transverse partition 3b into the vehicle frame 3, and from there via the rubber-metal bearings 4 and the drive axle 1 and its wheels to the floor or road surface. The rubber-metal bearings 4 must, therefore, be very stiff to guarantee the stability of the fork lift truck. Consequently, the rubber-metal bearings 4 cannot allow large spring deflections. As a result of which, irregularities in the road can be damped only to a small extent.

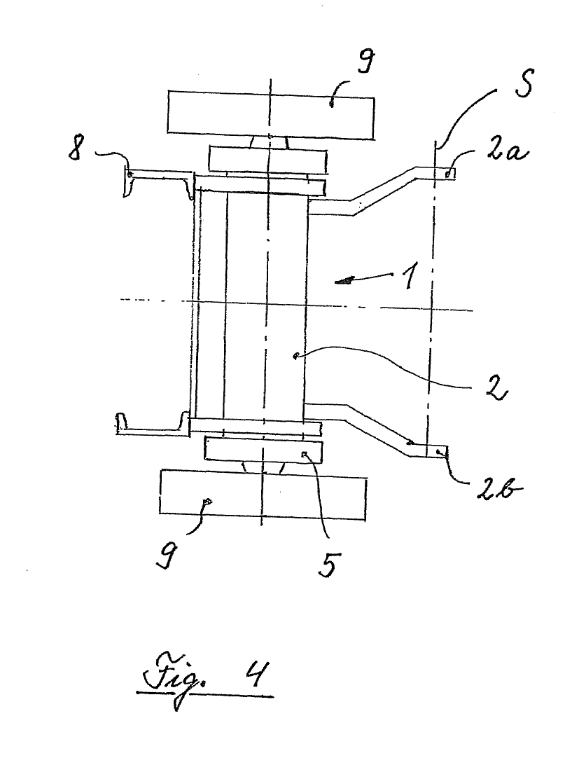

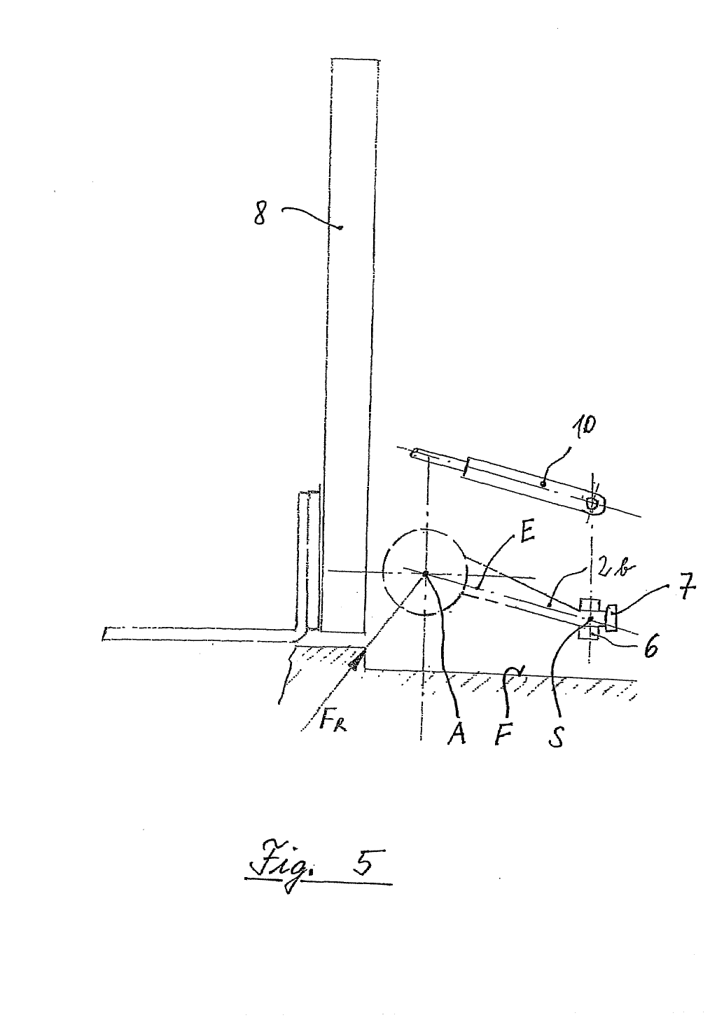

However, on the fork lift truck of the invention illustrated in FIGS. 3 and 4, a drive axle 1′ is provided, the construction of which is generally the same as the drive axle 1 illustrated in FIG. 1. This drive axle 1′ accordingly also has an axle body 2′ and a torque bearing in the form of torque arms 2a′, 2b′ extending toward the rear in the direction of travel and fastened to it. Relatively soft bearing elements 5 are in an operational connection with the axle body 2′, which bearing elements 5 are realized for the absorption of vertical forces and a great spring deflection. In contrast, relatively stiff rear bearing elements 6 are in an operational connection with the torque arms 2a′, 2b′. There are two forward and two rear bearing elements 5 and 6, respectively, at a spaced distance from each other in the transverse direction of the vehicle. Basically, however, it is also conceivable to have more or less than two bearing elements. The forward bearing elements 5 are illustrated only schematically in FIG. 3. For example, ring-shaped bearing elements can also be considered as a constructive solution (see overhead view in FIG. 4).

Impacts during travel caused by an irregular floor surface therefore cause a pivoting movement of the drive axle 1′ around the swiveling axis S, which is oriented horizontally and transversely in the vicinity of the rear bearing elements 6. The swiveling axis S is thereby not absolutely stationary with reference to its position on the vehicle frame (only half of the vehicle frame is shown for purposes of illustration), but can move slightly in the framework of the limited elasticity of the rear bearing elements 6.

To limit movements in the axial direction of the drive axle 1′, i.e., in the transverse direction of the vehicle, stops can interact with the axle body 2′. Alternatively, it is possible to realize the forward bearing elements 5 constructively so that they are in the position to also absorb transverse forces. Displacements of the drive axle 1′ toward the rear in the longitudinal direction of the vehicle are limited in this exemplary embodiment by stops 7 located on the rear end of the torque arms 2a′, 2b′. This function can optionally also be performed by the rear bearing elements 6.

A lift mast 8 is mounted on the axle body 2′ so that it can tilt relative to the drive axle 1′ around an axial centerline A. This can be achieved by a ring-shaped bearing that surrounds the axle body. The vertical forces Q generated by the weight of the load to be transported and the mass of the lift mast 8 are thereby transmitted, bypassing the elastic fastening of the drive axle 1′ and of the vehicle framework, directly via the axial body 2′ and the wheels 9 located on the ends of the axle body 2′.

The tilting movements of the lift mast 8 are produced by at least one tilting cylinder 10. Preferably, however, two tilting cylinders 10 at a spaced distance from each other in the transverse direction of the vehicle are provided, each of which is engaged with one of the side members of the lift mast 8. Each tilting cylinder 10 is coupled in an articulated manner by a forward tilting cylinder joint 10a with the lift mast 8 and by means of a rear tilting cylinder joint 10b with the vehicle frame.

To keep from producing undesirable tilting movement of the lift mast in the event of a deflection of the drive axle 1′, the tilting cylinder 10 is oriented parallel or approximately parallel to a plane E which extends from the axial centerline A to the swiveling axis S and/or is spanned by these lines. The result is, therefore, a joint polygon in the manner of a parallelogram with the joints S, A, 10a and 10b as the coupling points. It is thereby irrelevant whether the tilting cylinders 10 are located in the top position (as illustrated in broken lines in FIG. 3) or relatively close to the drive axle 1′, i.e., in the bottom position illustrated in FIG. 3. If the joint polygon forms an exact parallelogram, the result, in the event of a deflection of the drive axle 1′, is the lack of any tilting movements of the lift mast 8. Variances from the exact parallelogram shape, as illustrated in FIG. 3, are allowable, however, provided that relatively small tilting movements are tolerated.

In the variant of the fork lift truck of the invention illustrated in FIG. 5, the swiveling axis S is at a smaller vertical distance from the road F than the axial centerline A. On one hand, this arrangement saves space. On the other hand, there is an advantageous flow of forces in the vehicle frame. When the vehicle encounters irregularities in the road or floor, the deflection process is also facilitated because the wheel contact force Fr that acts at an angle to the surface when there are irregularities in the road F, is applied with a lowered swiveling axis S to an elongated lever arm. Higher speeds of travel during forward travel are thereby possible. In this variant of the invention, the tilting cylinders 10 are also oriented parallel to the plane E.

To keep the effort and thus the costs low, bush bearings or ball joint bearings can be used in the joints S, 10a and 10b. In particular, sufficient damping properties and structure-borne noise isolation can still be achieved on fork lift trucks with a drive axle driven by an electric motor, which theoretically tends to excite vibrations only to a small extent.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. Fork lift truck comprising:
a drive axle elastically fastened to a vehicle frame;
a lift mast connected with the drive axle and that can be inclined around an axial centerline of the drive axle by at least one tilting cylinder;
wherein the drive axle is fastened to the vehicle frame by forward bearing elements and by rear bearing elements of a torque bearing system;
wherein the rear bearing elements are located at a spaced distance from the forward bearing elements in a longitudinal direction of the vehicle;
wherein the forward bearing elements are configured to absorb vertical forces and the rear bearing elements are configured to absorb drive and braking torques;
wherein the drive axle is pivotable around a swiveling axis which is oriented horizontally and transversely in a vicinity of the rear bearing elements;
wherein the lift mast can be inclined relative to the drive axle; and
wherein the at least one tilting cylinder is connected in an articulated manner to the vehicle frame and the lift mast and is oriented parallel or approximately parallel to a plane which extends from an axial centerline to the swiveling axis.

2. The fork lift truck of claim 1, wherein the forward bearing elements are also configured to absorb horizontal transverse forces.

3. The fork lift truck of claim 1, wherein the drive axle has an axle body on which two torque arms that are at a spaced distance from each other and extend toward the rear are rigidly fastened, wherein the forward bearing elements are in an operational connection with the axle body, and wherein each rear bearing element is in an operational connection respectively with each of the torque arms.

4. The fork lift truck of claim 2, wherein the drive axle has an axle body on which two torque arms that are at a spaced distance from each other and extend toward the rear are rigidly fastened, wherein the forward bearing elements are in an operational connection with the axle body, and wherein each rear bearing element is in an operational connection respectively with each of the torque arms.

5. The fork lift truck of claim 1, wherein the swiveling axis is at a smaller vertical distance from a road than the axial centerline.

6. The fork lift truck of claim 2, wherein the swiveling axis is at a smaller vertical distance from a road than the axial centerline.

7. The fork lift truck of claim 3, wherein the swiveling axis is at a smaller vertical distance from a road than the axial centerline.

8. The fork lift truck of claim 4, wherein the swiveling axis is at a smaller vertical distance from a road than the axial centerline.
